(19) United States
(12) Patent Application Publication
(10) Pub. No.: US 2019/0188732 A1
(43) Pub. Date: Jun. 20, 2019

(54) SYSTEM AND METHOD FOR ENSURING CREDIBILITY OF ITEMS IN A SUPPLY CHAIN MANAGEMENT

(71) Applicant: Tommy Lee Hill, Cedar city, UT (US)

(72) Inventor: Tommy Lee Hill, Cedar city, UT (US)

(21) Appl. No.: 16/278,724

(22) Filed: Feb. 19, 2019

Related U.S. Application Data
(60) Provisional application No. 62/637,688, filed on Mar. 2, 2018.

(51) Int. Cl. G06Q 30/00; G06N 5/04; G06K 9/00

(52) U.S. Cl. CPC G06Q 30/0185; G06K 2209/01; G06K 9/00664; G06N 5/043

(57) ABSTRACT

The present invention relates to a system and a method for ensuring for ensuring the credibility of an item among a plurality of change in custody of the item in a supply chain management. The system and method is adapted to detect counterfeit, fraudulent and even defectives items among a plurality of change in custody of the item in a supply chain management. The system has self-evolving and self-learning capabilities. The system includes a vision module captures a raw data related to the said item via the at least one sensor based on the at least one action, an object recognition and optical character recognition (OCR) module configured to identify a primary data from the raw data based on at least one predefined parameter and generate a fingerprint data. The AI module is adapted to store the fingerprint data at every change in custody of the item.

### CROSS REFERENCE TO RELATED APPLICATION

This application claims the benefit of U.S. Provisional Application No. 62/637,688 filed on Mar. 2, 2018 which is incorporated by reference herein.

### FIELD OF DISCLOSURE

The present disclosure relates to ensuring the credibility of items in a supply chain management. More specifically, the present disclosure is adapted to tracking and authenticating the items at each change of custody point before reaching to a potential customer by using a distributed ledger network.

### BACKGROUND

In today's modern society, consumers are seeking information about the products with different aspects i.e. tracking, dispatch, checking, if goods are original or not etc. Everyone wants to have fresh food, if we would like to pay extra for truffles we would like to know from which region it is sourced/originated.

For many years the answer to the tracking of goods and management in the supply chain was Radio Frequency Identification tags (RFID). The tags work with various frequencies depending on the use. The RFID tags are useless if we are not able to use them in the right moments and as we are not able to store the information in a secure way.

The RFID evolution started with big computers in the Logistic centers and Shopping malls, then big corporates established their own IT infrastructure. Then the cloud computing came into the picture and from that moment Logistics companies and supply chain started to be able to store the data outside of the expensive own IT infrastructure. NFC and Mobile revolution is years ahead when Mobile devices are able to read RFID documents and information from the goods and food thanks to NFC technology.

In the field of computers, Logistics is the management of the flow of movable items between the point of origin and the point of consumption in order to meet requirements of end-customers, manufacturers, or a distribution node there between. One of the goals of a logistics data management system is to ensure security by tracking of goods through the entire supply chain from origin to consumption. Conventional tracking frequently involves a database at each node along a supply chain, where the database maps identifiers to intake shipping information. Cross-company tracking can occur if an entity correlates information from different databases using unique identifiers.

However, this method of cross-company tracking will require that individual company labels or otherwise identifies its shipments with the same identifiers as other companies. This is unpractical for many companies, especially when the packaging of items is changed from one company to another. For example, one company may label a case, whereas another company may label an entire pallet full of cases. Also, some companies' intake multiple components to create a composite item for sale. In these situations, conventional methods of tracking goods are difficult or impossible to implement.

Currently, existent anti-counterfeiting measures such as seals of authenticity, micro-printing, holographs, watermarks, human-invisible inks, encrypted micro-particles, and tamper-evident packaging can make counterfeiting more difficult but largely have failed to hamper the counterfeiting industry. Most of these countermeasures may themselves be counterfeited by more or less sophisticated methods. Moreover, frequently the more difficult a technology is for a counterfeiter to spoof, the costlier the technology is to implement. Thus, even when counter measures succeed in thwarting counterfeiters, the counterfeiters exact an indirect economic toll on honest merchants and manufacturers.

An ever-present problem of supply chain transactions is to guarantee that only the legitimately produced and distributed items are sold to consumers. In order to guarantee this, all of the entities in the legitimate supply chain should be able to verify that the goods are authentic, i.e. that a particular item was produced legitimately and followed its path through the legitimate supply chain. In other words, all of the entities in the legitimate supply chain should be able to verify the provenance of an item. At present, this problem is addressed by relying on physical security and trust to the previous owner. In effect, the supply chain is a chain of ownership and the new owner trusts the previous owner in its ability to verify provenance.

Further, the ownership of products or goods could be entered into a centralized register. This leads to security weaknesses, however, since the centralized register is the single point of verification. One alternative to a centralized register is to rely on physical tokens. The holder of the token is deemed to be the owner of the asset. This provides an unambiguous method of proving the ownership of an asset. However, such physical objects are cumbersome and insecure, as they can be lost, stolen or duplicated.

In the U.S. Pat. No. 964,134,2B2 Srinivasan Srira et.al discloses a method of tracking a chain of custody of an item in a supply chain. A computer system implements a computer interface with a distributed consensus network comprised of computing devices configured to verify one or more waiting transaction records for addition into one or more blocks in a block chain representing a cryptographically verifiable ledger. The order of the block chain is cryptographically protected against tampering by the computing devices. The computer system can track provenance of the item by identifying an existing record in the block chain. The existing record can place a first quantity of a first stock keeping unit (SKU) at a first address. The computer system can then unitize the item by publishing a new record to the block chain. The new record indicates the existing record as a source record and associates a new SKU with a destination address.

In an another US Patent Application 2017,033,189,6A1 Barry holloway et. al discloses a computer-implemented method for processing an asset within a supply chain includes: providing a first distributed ledger maintained by nodes within a first distributed consensus network; providing a second distributed ledger maintained by nodes within a second distributed consensus network creating the asset by a supply chain first entity associated with at least one node within the first network, and providing a digital certificate uniquely associated with the asset for authentication; creating a first transaction record in the first distributed ledger representing an asset transfer and its associated digital certificate from the first entity to a supply chain second entity associated with at least one node within the first network; and creating a second transaction record in the second distributed ledge representing an asset transfer and its associated digital certificate from the second entity to a supply chain third entity associated with at least one node within the second network.

In yet another US Patent Application 2016,009,873,0A1 Patrick Joseph Feeney discloses a method for block-chain verification of goods includes obtaining, by a first computing device, a first address. The method includes exporting, by the first computing device, the first address to a first code affixed to a first product. The method includes filing, by the first computing device, a first crypto-currency transaction to the first address, at a transaction register. The method includes receiving, by a second computing device, from a code scanner, the first address, scanned from the first code affixed to the first product. The method includes verifying, by the second computing device, the first crypto-currency transaction at the transaction register, using the first address. The method includes identifying, by the second computing device, based on the verification, that the first product is authentic.

Today, however, the technology called blockchain presents a whole new approach. The blockchain is a recent development in the field of computer science, which uses a global peer-to-peer network to provide an open platform that can deliver neutrality, reliability, and security. The basic mechanism was originally proposed as part of a solution for administering the shared accounting ledger underlying Bitcoin [“Bitcoin: A Peer-to-Peer Electronic Cash System”, Satoshi Nakamoto, 2008]. Beyond this initial financial application, blockchains can be generalized and used to implement an arbitrary set of rules that no one, neither the users nor the operators of the system, can break. They rely on a completely different system architecture that makes them a unique platform for applications involving multiple parties with little trust in each other; for example, fragmented supply chains.

In view of the above, there is a need for a fast, accurate, cost-effective, and robust anti-counterfeiting and product or item tracking system in the supply chain. The present invention provides a more secure way of transferring and authenticating items within or outside the supply chain.

There is a need for a better method for ensuring the credibility of items during changing custody of items at various points across the entire supply chain management.

### SUMMARY OF THE DISCLOSURE

It should be understood that this disclosure is not limited to the particular systems, and methodologies described herein, as there can be multiple possible embodiments of the present disclosure which are not expressly illustrated in the present disclosure. It is also to be understood that the terminology used in the description is for the purpose of describing the particular versions or embodiments only and is not intended to limit the scope of the present disclosure.

The present invention is directed to provide a system for ensuring the credibility of an item among a plurality of change in custody of the said item in a supply chain management. The said system and method has been designed in order to track counterfeit products in the supply chain management. The system comprises at least one computing device having a touchscreen for receiving an input from a user, the input relates to at least one action to be performed in relation to the item, a vision module communicably coupled to the said computing device and at least one sensor, such that the vision module captures a raw data related to the said item via the at least one sensor based on the at least one action and stores the raw data in a memory, an object recognition and character recognition (OCR) module configured to identify a primary data from the raw data based on at least one predefined parameter and store the primary data in the memory, wherein the primary data is associated with the said item and an artificial intelligence (AI) module adapted to retrieve the raw data and primary data from the memory to generate a second fingerprint data based on the primary data and the at least one predefined parameter, wherein the AI module is configured to identifying at least one first block having a first fingerprint data related to the item, the first block stored on a networked distributed ledger and creating a second block including the first fingerprint data and the second fingerprint data at every change in custody of the item in the supply chain management.

In an aspect of the present invention, the AI module rejects the change in custody of the item if the first fingerprint data is not identified on the networked distributed ledger.

In an aspect of the present invention, the AI module retrieves the primary data of the item from the memory and compare the primary data of the item with an abnormalities parameter related to the item and generate a result, wherein the artificial intelligence (AI) authenticate the item based on the result.

In an aspect of the present invention, the AI module checks for any abnormalities in the said report and alert the concerned authorities about abnormalities identified at which point.

In an aspect of the present invention, the AI module does not identify the first block on the networked distributed ledger, the AI module creates a genesis block and appends the second fingerprint data to the genesis block on the networked distributed ledger.

In an aspect, the present invention provides a method for ensuring the credibility of an item among a plurality of change in custody of the said items in a supply chain management. The method comprises receiving an input on a computing device from a user, the input related to information about the item, capturing raw data related to the said item via a sensor at a vision module and storing the raw data in a memory, identifying a primary data from the raw data based on at least one predefined parameter and store the primary data in the memory, the identification being done by an OCR module, wherein the primary data is associated with the said item, retrieving the raw data and primary data by an AI module to generate a second fingerprint data based on the primary data and the at least one predefined parameter, identifying at least one first block having a first fingerprint data related to the item, and creating a second block including the first fingerprint data and the second fingerprint data at every change in custody of the item on networked distributed ledger.

In an aspect, the present invention provides a device for ensuring the credibility of an item among a plurality of change in custody of the said items in a supply chain management. The device comprises at least one computing device which includes at least one display unit having at least user interface, at least one input unit, one processor, a communication unit, at least one sensor and a memory unit stored executing instructions. The device further includes one or more processor coupled to at least one display unit having at least user interface, at least one input unit, the communication unit, the at least one sensor and the memory, and responsive to executing the instructions, the processor performs operations comprising receiving an input on a computing device from a user, the input related to an action to be performed about the item, capturing raw data related to the said item via a sensor at a vision module and storing the raw data in a memory, identifying a primary data from the raw data based on at least one predefined parameter and store the primary data in the memory, the identification is done by an OCR module, such that the primary data is associated with the said item, retrieving the raw data and primary data by an AI module to generate a second fingerprint data based on the primary data and the at least one predefined parameter, identifying at least one first block having a first fingerprint data related to the item, such that the first block is stored on a networked distributed ledger and creating a second block including the first fingerprint data and the second fingerprint data at every change in custody of the item on networked distributed ledger.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a complete understanding of the present invention, reference is now made to the following descriptions taken in conjunction with the accompanying drawing, in which:

FIG. 1 illustrates a block diagram for a system for ensuring the integrity of items in a supply chain management according to the various embodiments of the present invention;

FIG. 2 illustrates a schematic diagram for a block chain system, according to various embodiments of the present invention;

FIG. 3A illustrates a flowchart for a method for ensuring the integrity of items, according to various embodiments of the present invention;

FIG. 3B illustrates a flowchart for a method for rejecting the change in custody of items in a supply chain management, according to various embodiments of the present invention and

FIG. 4 illustrates a flowchart for a method for identifying counterfeiting items in a supply chain management, according to various embodiments of the present invention.

Like numerals refer to like elements throughout the present disclosure.

### DETAILED DESCRIPTION OF THE INVENTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples of other possible examples.

As will be appreciated by one skilled in the art, aspects of the present invention may be embodied as a system, method or computer program product. Accordingly, aspects of the present invention may take the form of an entire hardware embodiment, an entire software embodiment (including firmware, resident software, micro-code, etc.), or an embodiment combining software and hardware. Furthermore, aspects of the present invention may take the form of a computer program product embodied in one or more the computer readable medium(s) having computer readable program code embodied thereon.

Any combination of one or more computer readable medium(s) referred herein as memory or storage unit may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code or software embodied on a computer readable medium may be transmitted using any appropriate medium, including but not limited to wireless, wired, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a stand-alone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

The term “means” as used herein shall be given its broadest possible interpretation in accordance with 35 U.S.C., Section(s) 112(f) and/or 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, a brief description of the drawings, detailed description, abstract, and claims themselves.

The term “module” such artificial intelligence module used herein refers to any known or later developed hardware, software, firmware, artificial intelligence, fuzzy logic, machine learning algorithm, deep learning algorithm or combination of hardware and software that is capable of performing the functionality associated with that element. The module can consist of a software agent, a fuzzy logic algorithm, a predictive algorithm, an intelligence rendering algorithm, object recognition module and optical character recognition and a self-learning (including relearning) algorithm. It should be noted that the self-learning (including relearning) algorithm can include a self-learning artificial intelligence algorithm and/or a self-learning neural network algorithm and/or a quantum computer enhanced machine learning algorithm.

The terms “determine”, “calculate” and “compute,” and variations thereof, as used herein, are used interchangeably and include any type of methodology, process, mathematical operation or technique.

The term “computing device” described herein below refers to any processing device, and may include mobile phones, smartphones or PDAs, Tablet, Kiosk, computing devices and the like. In one embodiment, a computing device is a touchscreen device for receiving input from a user via touch, voice, gesture and other computing devices.

The term “item” described herein below refers to any product, goods, article, food, electronic circuit or IC chips, medicine, doctor prescription, medical devices and may include any product which is used as a commodity and sell/purchased/manufactured.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks. As used herein, a “terminal” or node or computing device should be understood to be any one of a general purpose computer, as for example a personal computer or a laptop computer, a client computer configured for interaction with a server, a special purpose computer such as a server, or a smartphone, tablet computer, personal digital assistant or any other machine adapted for executing programmable instructions in accordance with the description thereof set forth above.

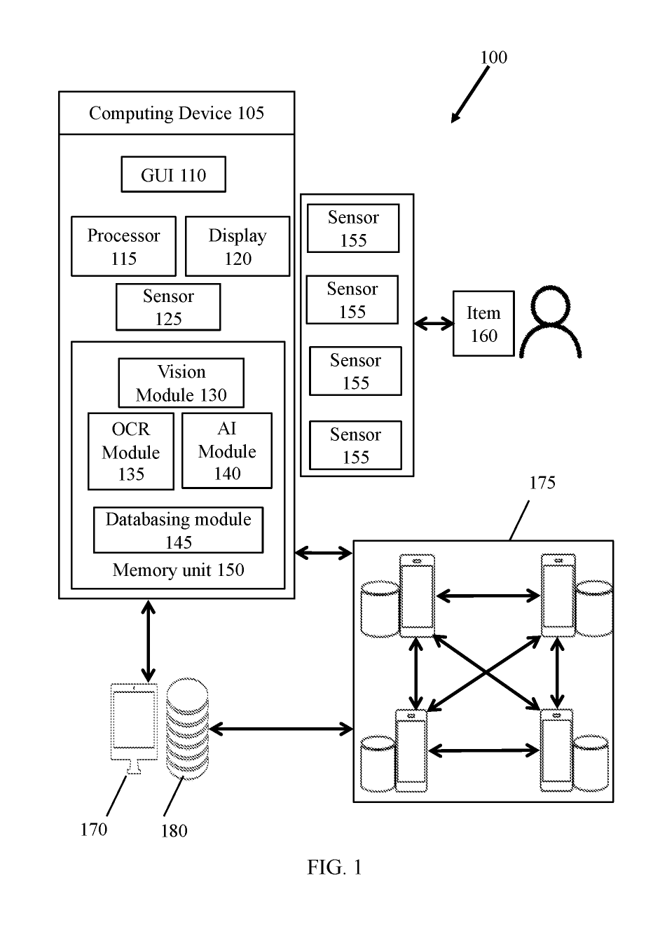

Some embodiments of this invention, illustrating all its features, will now be discussed in detail with respect to FIGS. 1 to 4.

The present invention relates to a system and method for ensuring the credibility of an item among a plurality of change in custody of the said item in a supply chain management. The said system and method has been designed in order to track counterfeit products in the supply chain management. The system comprises at least one computing device having a touchscreen for receiving an input from a user, the input relates to at least one action to be performed in relation to the item, a vision module communicably coupled to the said computing device and at least one sensor, such that the vision module captures a raw data related to the said item via the at least one sensor based on the at least one action and stores the raw data in a memory, an object recognition and character recognition (OCR) module configured to identify a primary data from the raw data based on at least one predefined parameter and store the primary data in the memory, wherein the primary data is associated with the said item and an artificial intelligence (AI) module adapted to retrieve the raw data and primary data from the memory to generate a second fingerprint data based on the primary data and the at least one predefined parameter, wherein the AI module is configured to identifying at least one first block having a first fingerprint data related to the item, the first block stored on a networked distributed ledger and creating a second block including the first fingerprint data and the second fingerprint data at every change in custody of the item in the supply chain management.

The term supply chain management is defined as the management of the flow of goods and services including design, planning, execution, control, and monitoring of supply chain activities with the objective of creating net value, building a competitive infrastructure, leveraging worldwide logistics, synchronizing supply with demand and measuring performance globally. Once a product is manufactured at a manufacturer's location, the product includes various information about it. The product has a packaging, a label with a barcode or QR code, the model number printed on the label, the date of manufacturing of the product, and many more details. The said details of the product/item are stored in the remote database in the memory. The block chain employed in the present invention includes at the time of manufacture, Genesis moment (Genesis moment is when the birth record is first created and will record any information as defined by the requirements of the AI including but not limited to manufacturer, model, UPC number, lot number, serial number, date, time etc.).

It adds a development record. The development record appends the birth record with all pertinent information that is defined by the AI at that time. The development record can only add information; it cannot change or remove any records or information existing to that point. This development record adds a new fingerprint certifying the information. This certifying process includes specific information about the machine that made this development record including but not limited to date, time, location, user (if applicable). A permanent record of the fingerprint is made in the block chain.

Referring to FIG. 1 of the drawings, there is shown a system 100. The said system 100 shows a user operating a computing device 105 which includes a touchscreen for inputting information. It will be apparent to a person skilled in the art that a computing device relates to any processing device such as desktop computer, laptops, tablets etc. The said computing device 105 includes a user interface of a pre-stored application for receiving an input from the user. The user enters an input in the said Graphical User Interface, GUI 110. The input may relate to at least an action to be performed by the user such as the purchase of an item 160, return of an item 160, transfer of custody of an item 160 and the like.

In the present system, the computing device 105 comprises a processor 115 and a display 120 and an internal sensor 125.

Additionally, there is a memory unit 150 is having a core module which includes a Vision Module 130, an optical character recognition (OCR) module 135, an artificial intelligence (AI) module 140, object recognition module and a databasing module 145. The vision module 130 is configured to capture raw data related to the said item 160 via internal and the external sensor 155. The raw data relates to information about the item such as the type of item, date of manufacturing of the item, the model number of the item, the brand name of the item and the like. These should not be construed as a limitation, there can be additional information also.

In one embodiment of the present invention, the core module is a software module that accommodates all the other software modules. The core module is a controller module which controls all module and their functionality. The core module is adapted to trigger or activate other module based on the user input and system or device requirement. The core module gives out instructions, gets back data and then gives out more instructions and also helps in training and reinforcing the learning of all the other modules i.e. vision module 130, the object recognition module, the OCR module 135, the databasing module 145 and AI module 140. Further, the AI module 140 is having a decision-making module in order to make decisions based on the received item information and inputs from various modules. Furthermore, the databasing module 145 is indexing, categorizing, and cataloging of the primary and raw data in the database.

In one embodiment of the present invention, the Vision Module 130, the OCR module 135, the AI module 140 and the Core or controller module are software agents or modules which are capable of performing all the functionality as described herein. The Vision Module 130, OCR module 135, AI module 140, and the core module are communicable coupled to all the component of the system to perform various functionality. The Vision Module 130, OCR module 135, AI module 140, and Core or controller module are software agents or modules which executed or run by at least one processor. The Vision Module 130, OCR module 135, AI module 140, Core or controller module are adapted to run in any computing device such mobile phone, kiosk, laptop, tablet, and processor enable computing device.

In one embodiment of the present invention, the Core module is adapted to monitor the GUI 110, sensors 155, Vision Module 130, OCR module 135 and AI module 140 and their functionality. The Core module is connected to each of the module (130, 135, 140, 145), the processor 115, GUI 110, the sensors 155, blockchain 175, server 170 and storage devices (remote database) 180. The Core module allows all the component of the system to communicate with each other and perform their functionality based on the input received.

The sensors 155 are selected from at least one of a Digital Camera, Video Device, Microscopic Camera, high resolution image sensor, motion sensor, weight sensor, x-ray sensor, camera sensor, Temperature Sensor, Proximity Sensor, Accelerometer, IR Sensor (Infrared Sensor), Pressure Sensor, Light Sensor, Ultrasonic Sensor, Smoke, Gas and Alcohol Sensor, Touch Sensor, Color Sensor, Humidity sensor, Tilt Sensor, Flow and Level Sensor, Touch Sensor, barcode reader, RFID reader. X-Ray, SEM or other sensory/validation devices and the combination thereof.

The raw data captured is stored in a memory unit 150. Further, the Core module, the vision module 130, the OCR module 135, the AI module 140 and the databasing module 145 are stored in the memory unit 150.

The optical character recognition (OCR) module 135 is configured to identify a primary data from the raw data based on at least one predefined parameter and stores the primary data in the memory unit 150. The identified primary data is associated with the said item 160.

The system 100 includes an Artificial Intelligence (AI) module 140 adapted to retrieve the raw data and primary data from the memory and generates a second fingerprint data based on the primary data and the at least one predefined parameter. The AI module 140 is adapted to accept all data and images and builds profiles for the item. The AI module 140 is adapted to create a learning database or training database information to improve its functionality for future images. The AI module 140 is adapted to analyze all captured OCR data to perform a search against blockchain relation item database. For example, Make: Lenovo|Model: Y580p|Serial Number: CB31957208| Mfg. Date: 09/19/17.

In one embodiment of the present invention, the Core or controller module program instruct the AI to Generate a hash or the Core program can generate the hash. It will be dependent on what type of working is being recorded.

The system 100 includes at least one remote server 170 having a remote database 180. The at least one remote server 170 is connected to each node or computing device in the block chain system. Each node or computing devices are interconnected to each other and creating a distributed ledger or blockchain environment. The AI module 140 present in each node is adapted to send information when the item 160 is processed, to the remote server 170 and store in the remote database 180. The remote database 180 stores all the raw data, primary data, fingerprint data, abnormalities identification parameter. The remote database is self-updating or self-learning or a trained database which is trained by the AI module 140.

The AI module 140 integrates stored information, real-time information, information/data/image(s) from the object/array of objects (where the object can be coupled with a wireless (or radio) transmitter and/or a sensor) and the unified algorithm (which includes a software agent, a fuzzy logic algorithm, a predictive algorithm, an intelligence rendering algorithm and a self-learning (including relearning) algorithm). The AI module 140 and OCR module 135 perform artificial intelligence, data interpretation, data mining, machine vision, natural language processing, neural network, object recognition, pattern recognition reasoning, and modeling.

In an embodiment, at the retailer end, the AI module 140 is trained to pre-store information about every item stocked in the respective store. It includes a huge reference library for all different shapes and sizes and other identifying characteristics that may be visible.

The AI module 140 is configured to identify at least a first block which has a first fingerprint data related to the item. The said first block is stored in a networked distributed ledger.

In an embodiment, the AI module 140 also generates a second fingerprint based on the image, which includes characteristics of the item but not limited to manufacturer, model, UPC number, lot number, serial number, date, time etc. It also identifies any packaging details such as whether the item is sealed in manufacturer's original packaging, the item has been opened but is in original manufacturer packaging, loose item, if it is a loose item it will verify cosmetic condition and completeness i.e. if anything is broken, crack, scratched, missing such as accessories etc.

The AI module 140 creates a second block including the first fingerprint data and the second fingerprint data at every change in custody of the item in the supply chain management.

The AI module 140 authenticates the item after matching the second fingerprint data with pre-stored data created before for example at manufacture end or logistic end or others.

Once authenticated, the AI module 140 sends a confirmation notification to delivery to search and select best delivery service or user its own delivery services.

After selecting the delivery service, AI module 140 updates the second fingerprint data when the product is handed over to the delivery person and uploaded to block chain database or ledger.

The second fingerprint data is updated every time the custody of the item is changed from one custody to another.

In an embodiment, the first fingerprint and the second fingerprint comprise time stamp when the fingerprints are created at every node or change of custody point. The time stamp enables the identifying of the last point of custody where the fingerprint has been generated. The time stamp could be in format such as [hh]: [mm]: [ss].

After the AI module 140 has produced primary data from the analysis of the Vision component inputs, the AI module 140 takes all data and generates, calculates or computes a cryptographic hash or fingerprint data. The cryptographic hash stores any or all relevant, identified, discovered, generated, calculated, defined and or predefined data as determined by both inputs from the Vision module 130 and inputs from the Artificial Intelligence module 140. This data can include external data from additional inputs. This data from additional inputs can include internal or external sensors, external or internal data observed, analyzed, identified, discovered, generated, and calculated during the manufacture, production, testing, analysis or another process of the item and or process.

Once the Cryptographic Hash is generated, also known as a Block, it will then be recorded and or registered on the Blockchain and or relevant database, dataSet or another registry. The Cryptographic Hash is to include any and all analysed, identified, discovered, generated, calculated data and which may or will contain any or all information as to company, operator, location, time, date and other relevant data including data related to the use of, operation of, software of, license of, security of, value of, owner of and other relevant of.

Once the cryptographic hash or fingerprint data is recorded to the block chain component and or relevant database, DataSet and or another registry the process is now complete and the record will now be available to the inquiry at any time by repeating the process as stated above.

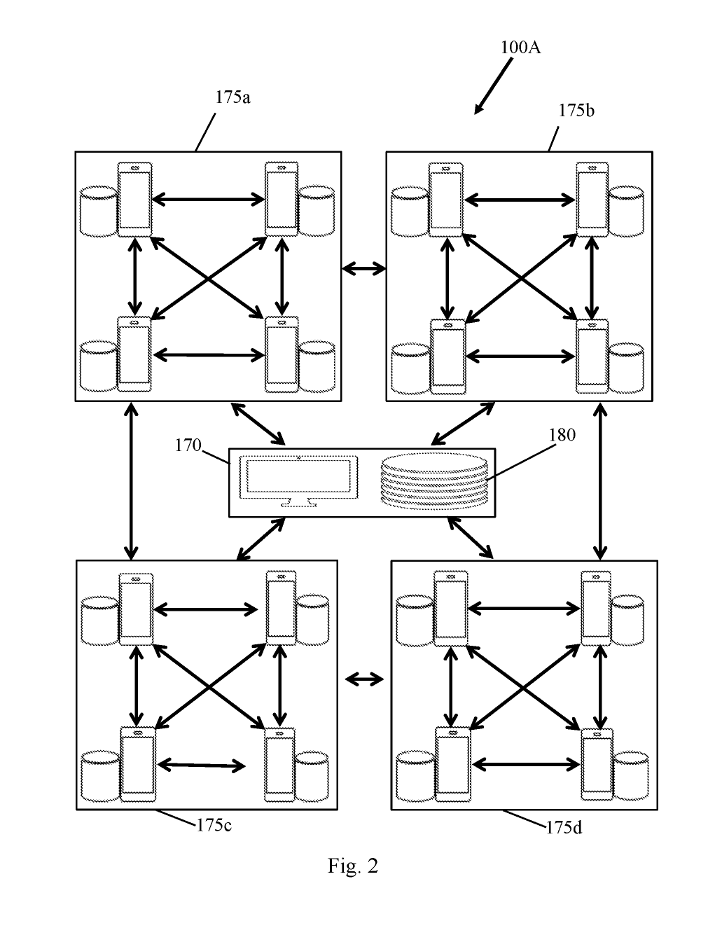

Referring to FIG. 2, there is shown a schematic diagram of a block chain system 100A. Each of the block chains 175a, 175b, 175c, and 175d are linked to the remote server 170 which comprises a remote database 180. The said remote database 180 is relational in nature. For example, the block chain 175a could be the chain of events followed at manufacturer's end where each of the block generated at various points includes information about the making of the product. Similarly, the block chain 175b could relate to the creation of various blocks at the wholesaler's end.

Such block chain management at various points in the lifecycle of a product enables more security to the product and maintaining the authenticity of the product. Further, such blockchain facilitates the identification of any fraudulent activity or any abnormalities if occurred at any point of change in custody.

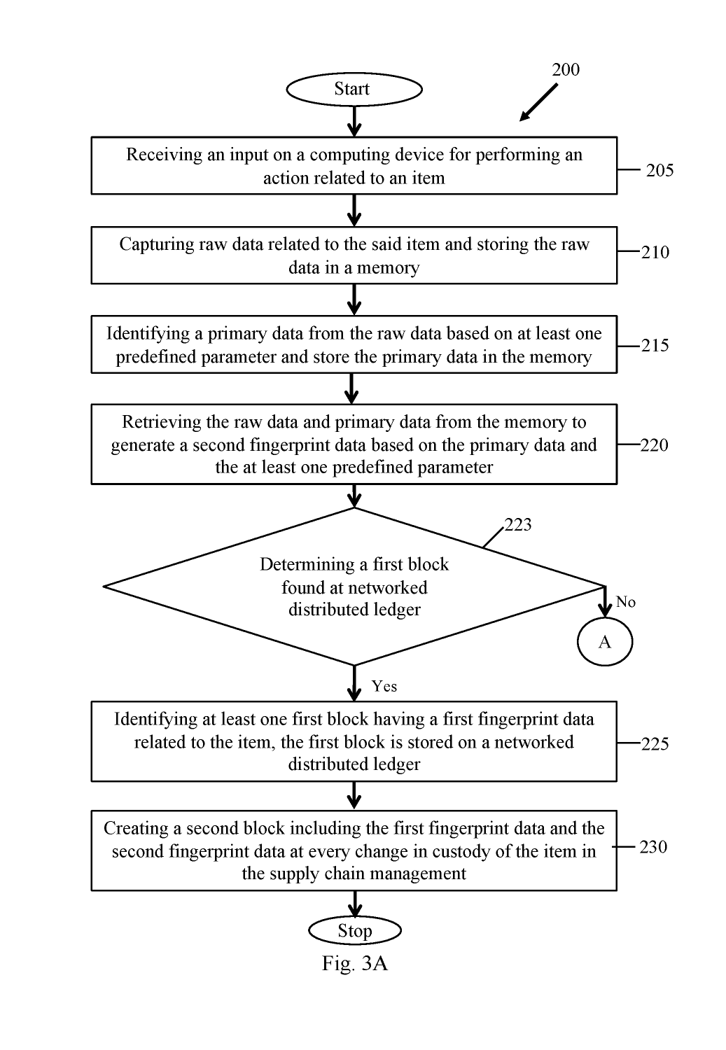

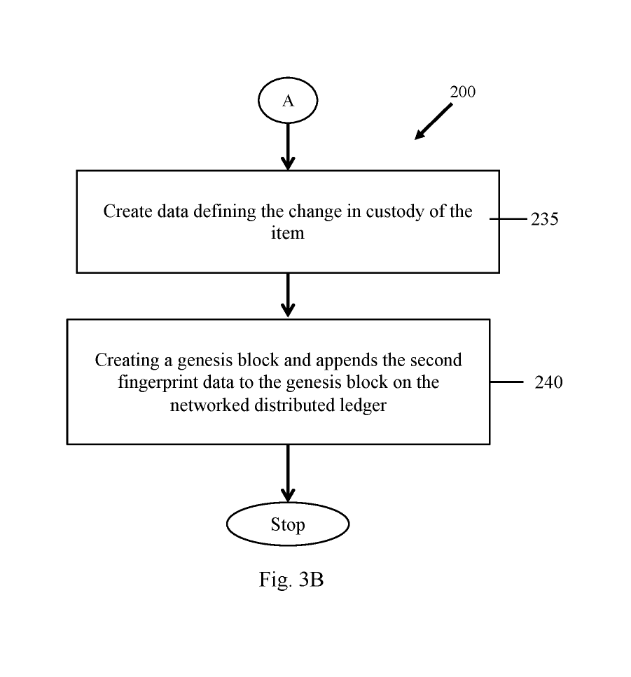

Referring to FIG. 3A, there is disclosed a method 200 for ensuring the credibility of an item among a plurality of change in custody of the said items in a supply chain management. The method 200 starts at step 205 for receiving an input on a computing device for performing an action related to an item. The said input is received on a user interface of a pre-stored application on a computing device 105. The user enters an input in the said user interface. The input relates to at least an action to be performed by the user such as the purchase of an item, the return of an item, transfer of custody of an item and the like. The item is processed every time at each change of custody point by computing device. The new user is adapted to process the item before accepting it via the computing device. The processing of item means the item is scanned, verified and a block is created where the information is stored in block chain distributed ledger at each point where the custody of the item changed.

Upon receiving the input from the user, at step 210, the vision module 130 is adapted to activate all the sensors which capturing of raw data of the item. The said sensors are at least one of a Digital Camera, Video Device, Microscopic Camera, high resolution image sensor, motion sensor, weight sensor, x-ray sensor, camera sensor, Temperature Sensor, Proximity Sensor, Accelerometer, IR Sensor (Infrared Sensor), Pressure Sensor, Light Sensor, Ultrasonic Sensor, Smoke, Gas and Alcohol Sensor, Touch Sensor, Colour Sensor, Humidity sensor, Tilt Sensor, Flow and Level Sensor, Touch Sensor, barcode reader, RFID reader. X-Ray, SEM or other sensory/validation devices and the combination thereof.

The raw data includes data of the item captured by each of the sensors which includes barcode information, RFID information, images of packaging, image of the item or package, X-ray images from all side, weight of the item, items, printing pattern or colour used on the packaging, watermark information, packaging, labelling and markings and the like. Once the raw data is captured, it is stored in the memory via the vision module 130.

In an embodiment, the raw data relates to information about the item such as UPC code, serial number, the type of item, date of manufacturing of the item, the model number of the item, the brand name of the item and the like. These should not be construed as a limitation, there could be additional information also.

At step 215, after capturing and storing the raw data, the system is adapted to send the raw data to OCR module 135, the OCR module is adapted to identify the important information or primary data from the raw data based on at least one predefined parameter and store the primary data in the memory. The identification of primary data is performed by identifying the region of interest in the image and identifying the object or character in that region. If the region of interest includes characters, the OCR module 135 is adapted to identify the letters and make meaning full data. Further, if the region of interest is an object or an image related to the item, then the OCR is adapted to identify the image for example whether the image is laptop image or mobile phone image etc. and cataloged the primary data the stored the databased within the memory.

Further, OCR module 135 includes a logic connected to a database such that the database includes pre-stored cataloged data of image and characters from the pre-stored image. The data is collected whenever an item is processed. The OCR module 135 identifies the region of interest based on object and character recognition algorithm and compares with pre-stored data to identify the item and its information. In an embodiment, whenever a new or unique image or character/object is unrecognizable, then a manual input about the image or character/object is provided by the administrator. That information of a new or unique image or character/object if unrecognizable is stored in the data and cataloged. So, that if in future, the same type of character or object or image comes, the OCR module recognizes it and catalogs the data. This process is also known as a self-learning process which is achieved by using machine learning and deep learning software. The region of interest is identified based on the at least one predefined parameter. The at least one predefined parameter includes item related information such as the type of item, serial number, maker information, manufacturing information or any information related to the item.

At step 220, AI module 140 is configured to retrieve the raw data and primary data from the memory to generate a second fingerprint data based on the primary data and the at least one predefined parameter. The AI module 140 is adapted to use the cataloged data stored in the memory to create a learning database. The learning database is updated automatically whenever a new, unique data or unrecognizable data is cataloged so that the cataloged data is used in the future for identifying the information by comparing with the pre-stored cataloged data.

In an embodiment, at the retailer end, the AI module 140 is trained to pre-store information about every item stocked in the respective store. It includes a huge reference library for all different shapes and sizes and other identifying characteristics that may be visible.

At step 223, the AI module 140 identifies a first block related to the identified product is determined in a networked distributed ledger. If the first block is found at step 223, the method moves to step 225.

If the first block is not determined at step 223, the method moves to next flow “A” which is explained later in the description.

At step 225, identification of at least one first block having a first fingerprint data related to the item, the first block is stored on a networked distributed ledger. The first fingerprint data is created at the previous change of custody point by a computing device by processing the item in the same manner described above. The networked distributed ledger relates to a replicated, shared and synchronized digital data which is accessible to all the points for changing the custody of the item in the supply chain management system.

Referring again to method 200, at step 230, creating a second block including the first fingerprint data address and the second fingerprint data at every change in custody of the item in the supply chain management.

Referring to FIG. 3B, when the first block is not identified at step 223, the method is adapted to reject the change in custody of the item at step 235. The AI module 140 identifies the last custody of the item at this step and generates a second fingerprint data. The AI module 140 then creates a genesis block and appends the second fingerprint data to the genesis block on the networked distributed ledger at step 240.

The present system and method are configured to identify the counterfeit product, if found in the supply chain management.

In one embodiment, AI module 140 is adapted to store the raw data captured by each sensor 155 at each change of custody in the remote database connected to the remote server 170. The AI module 140 is adapted to store the primary data generated at each change of custody in the remote database connected to the remote server 170. The AI module 140 is adapted to store the fingerprint data or hash value generated at each change of custody in the remote database. The AI module 140 is adapted to encrypt all the data generated at each change of custody in the remote database connected to the remote server 170.

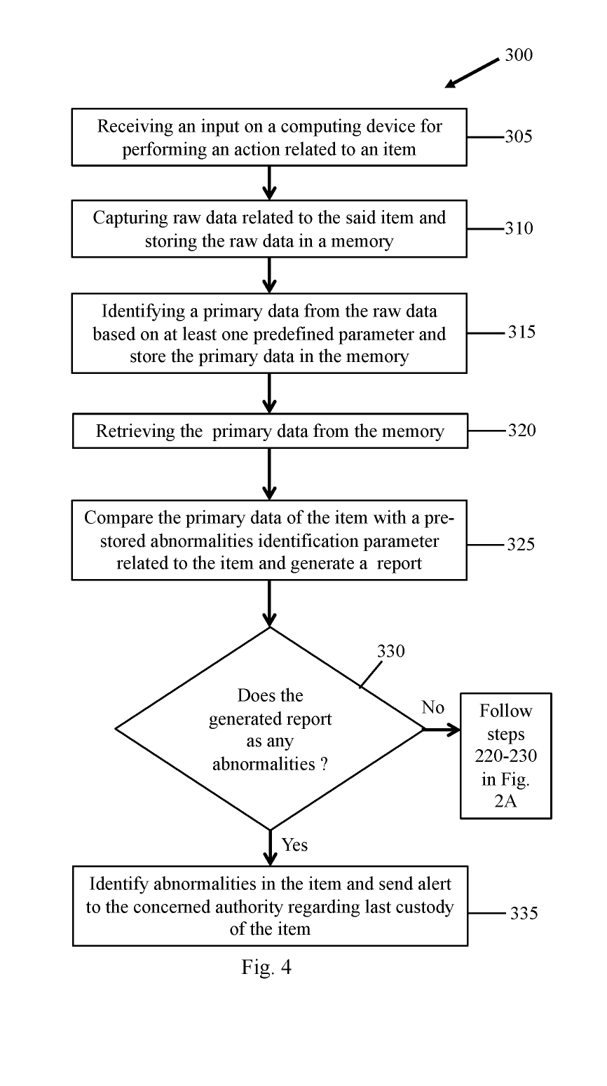

Referring to FIG. 4, there is provided a flowchart for the method 300. The said method 300 starts at step 305 for receiving an input on a computing device for performing an action related to an item. The said input is received on a user interface of a pre-stored application on a computing device 105. The user enters an input in the said user interface. The input may relate to at least an action to be performed by the user such as the purchase of an item, the return of an item, transfer of custody of an item and the like. The item is processed every time at each change of custody point by computing device. The new user is adapted to process the item before accepting it via the computing device. The processing of item means the item is scanned, verified and a block is created where the information is stored in block chain distributed ledger at each point where the custody of the item changed.

Upon receiving the input from the user, at step 310, the vision module 130 is adapted to active all the sensors which capturing of raw data of the item. at least one of a Digital Camera, Video Device, Microscopic Camera, high resolution image sensor, motion sensor, weight sensor, x-ray sensor, camera sensor, Temperature Sensor, Proximity Sensor, Accelerometer, IR Sensor (Infrared Sensor), Pressure Sensor, Light Sensor, Ultrasonic Sensor, Smoke, Gas and Alcohol Sensor, Touch Sensor, Color Sensor, Humidity sensor, Tilt Sensor, Flow and Level Sensor, Touch Sensor, barcode reader, RFID reader. X-Ray, SEM or other sensory/validation devices and the combination thereof

At step 315, after capturing and storing the raw data, the system is adapted to send the raw data to OCR module 135, the OCR module is adapted to identify the important information or primary data from the raw data based on at least one predefined parameter and store the primary data in the memory. The identification of primary data is performed by identifying the region of interest in the image and identifying the object or character in that region. If the region of interest includes characters, the OCR module 135 is adapted to identify the letters and make meaning full data. Further, if the region of interest is an object or an image related to the item, then the OCR is adapted to identify the image for example whether the image is laptop image or mobile phone image etc. and cataloged the primary data the stored the databased within the memory.

At step 320, AI module 140 is configured to retrieve the raw data and primary data from the memory to generate a second fingerprint data based on the primary data and the at least one predefined parameter. The AI module 140 is adapted to use the cataloged data stored in the memory to create a learning database. The learning database is updated automatically whenever a new, unique data or unrecognizable data is cataloged so that the cataloged data is used in the future for identifying the information by comparing with the pre-stored cataloged data.

At step 325, comparing of the primary data of the item with a pre-stored abnormalities identification parameter related to the item is done and generating an abnormalities report. The abnormalities identification parameter includes x-ray images, weight of the item or sub-items within the package, total weight of the item with or with packaging, printing pattern, text style, coloured used on the text or colours used on the packaging, watermark information, completing packaging information, labelling information and special markings, barcode information, item information such as UPC code, serial number, manufacturer name, data captured by each sensor when item is processed by the system at genesis or first time and the like.

In one embodiment, the abnormalities can be of different types such as missing sub items form the items, counterfeit product, damaged item, seal broken, soiled, water or excess moisture within the package.

In one embodiment, to identify the abnormalities, AI matches the weight of the item, if there is any difference in weight, there is an indication of missing sub items, and system identifies the sub-item based on the amount, weight is less which is equal to the at least one sub item weight, so it generates a missing part alert.

In one embodiment, AI module 140 matches the pre-stored x-rays images, with current x-ray image, if there is any difference in new pattern or sign appears in the new x-ray images, there AI module identifies whether it is within the threshold level or not and make a decision. If not, the AI module is adapted identified it as a damaged less which is equal to the at least one sub item weight, so it generates a missing part alert.

Similarly, other sensor inputs are mapped with the pre-stored input of the same type of sensors to find abnormalities. The AI module 140 updates all the abnormalities in the learning database, so that it can be used in the future for detecting the abnormalities.

At step 330, the system is adapted to check for any abnormalities in the abnormalities report.

If abnormalities are found at step 330, the method 300 moves to step 335 where it identifies the abnormalities identified related to the item and sends alert to the concerned authority about the type of abnormalities along with last custody of the item along with time stamp of the last custody and current custody. Further, the said alert information also includes the information of the custody agent or user, so that liability can be determined.

In an embodiment, the at each change of custody, the agent or the user is adapted to register to the system or at each exchange of custody, a unique ID is provided to each user at each change of custody. Further, the system is adapted to confirm the agent information at each change of custody. The agent information can be user account information or the employee ID card.

If the abnormalities are not found at step 330, the method 300 follows the steps 220-230 as described in FIG. 2A.

In an exemplary embodiment, during manufacturing of the item/product, the manufacturer starts a Genesis Block to record all applicable data (6W) such as who made it? what was made? When was it made, where was it made, why was it made? Who was it made for? and the like.

The next stage involves the Wholesaler/Supplier who checks the item in along the supply chain with relevant data such as when, where, who, condition (Hash Generated). Thereafter, Retailer/Reseller checks in the item along the supply chain. (Hash Tracked & updated)

At the retailer, the end user or the Customer purchases the item and the retailer/e-commerce has a record of the sale. Customer may elect to opt in at the time of the sale to record personally identifiable data on a customized website. This is added by the customer by either telling or entering the retailer their ID for the said website. If they purchase it through e-commerce/online/mobile app and they select or tell what items they want to be linked to their account on the said website. This is performed by showing to the retailer, a mobile phone with the app running and displaying a QR code such as “ [symbol] ” to link the account.

Alternatively, a Hash URL for example, www.bcurl.io/x9v34 is printed on a receipt and the customer then logging to his/her account and adds item and notification settings if different from preset settings.

It is important to note that the personally identifiable data is at the customer's discretion and choice of how much or how little they want to be listed and the customer is provided with a public or private setting on their profile on the website. In the public setting mode anyone can go online and punch in this information such as Make, Model & Serial Number and the system provides who is the current owner and how to contact them, may or may not list name, address, phone, email etc.

Whereas the Private setting means only vetted parties such as law enforcement or by a court order only have access to this personal info. This personally identifiable data is important in the event if the item is lost, stolen or damaged. This way Pawn Shops, Law Enforcement and Good Samaritans could contact the customer/end user. Good Samaritans can only send a message through the website and no personally identifiable information may be provided unless it is made public by the Customer. As the customer can register any item in this system through a simple web portal or at the time of checkout at the store or on an e-commerce website. Customer may also modify this record to contain additional data relevant to the item, its condition, its functionality, its ownership. Additionally, the customer may flag it Stolen or Lost, Lost with Reward.

The present system can be adapted to run on various platforms such as Sales Kiosk, Return Kiosk, Handheld Scanner, Mobile Phone, Party Platform or Custom Platform.

The present invention is novel and inventive and has many advantages over the existing prior arts. The present system, method, and device are capable of ensuring the credibility of items in a supply chain management. The said system allows the identification of the last point of custody where any fraudulent activity or any damage to the item has occurred. The time stamping further provides accurate results. Furthermore, this ensures rejection of the change in custody in case any abnormalities are found in the product. Such rejection does not allow the delivery of counterfeit product, or damaged product to the end user. Such systems and methods enable the user to track the real-time status of the product.

The terms “a,” “an,” “the” and similar referents used in the context of describing the invention (especially in the context of the following claims) are to be construed to cover both the singular and the plural unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

It is contemplated that numerical values, as well as other values that are recited herein, are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or another multiple of the actual value indicated, and/or described in the disclosure.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Although specific embodiments and certain structural arrangements have been illustrated and described herein, it will be clear to those skilled in the art that various other modifications and embodiments may be made incorporating the spirit and scope of the underlying inventive concepts and that the same is not limited to the particular methods and structure herein shown and described except insofar as determined by the scope of the appended claims.

What is claimed is:

1. A system for ensuring the credibility of an item among a plurality of change in custody of the said item in a supply chain management, the system comprising:
at least one computing device having an input unit for receiving an input from a user, the input relates to at least one action to be performed in relation to the item;
a vision module communicably coupled to said at least one computing device and at least one sensor;
wherein said vision module captures a raw data related to the said item via the at least one sensor based on the at least one action and stores the raw data in a memory;
an object recognition and an optical character recognition (OCR) module configured to identify a primary data from the raw data based on at least one predefined parameter and store the primary data in the memory;
wherein the primary data is associated with said item, and an artificial intelligence (AI) module adapted to retrieve the raw data and primary data from the memory to generate a second fingerprint data based on the primary data and the at least one predefined parameter;
wherein the AI module is configured to;
identifying at least one first block having a first fingerprint data related to the item, the first block stored on a networked distributed ledger; and
creating a second block including the first fingerprint data and the second fingerprint data at every change in custody of the item in the supply chain management.

2. The system as claimed in claim 1, wherein the AI module rejects the change in custody of the item if the first fingerprint data is not identified on the networked distributed ledger.

3. The system as claimed in claim 1, the AI module retrieves the primary data of the item from the memory and compares the primary data of the item with an abnormality identification parameter related to the item and generate a result, wherein AI module authenticates the item based on the result.

4. The system as claimed in claim 3, wherein the AI module identifies the abnormalities in the report based on the generated result and sends an alert to the authorities, wherein the alert includes information of last change of custody.

5. The system as claimed in claim 1, wherein the AI module does not identify the first block on the networked distributed ledger, the AI module creates a genesis block and appends the second fingerprint data to the genesis block on the networked distributed ledger.

6. The system as claimed in claim 1, wherein the AI module is adapted to catalog the raw data and primary data.

7. The system as claimed in claim 1, wherein the second fingerprint data is an encrypted data which includes a hash data.

8. A method for ensuring the credibility of an item among a plurality of change in custody of the said items in a supply chain management, the method comprising:
receiving an input on a computing device from a user, the input related to an action to be performed for an item;
capturing raw data related to the said item via a sensor at a vision module and storing the raw data in a memory;
identifying a primary data from the raw data based on at least one predefined parameter and store the primary data in the memory, the identification is done by an object recognition and optical character recognition (OCR) module, wherein the primary data is associated with the said item;
retrieving the raw data and primary data by an AI module to generate a second fingerprint data based on the primary data and the at least one predefined parameter;
identifying at least one first block having a first fingerprint data related to the item, wherein the first block is stored on a networked distributed ledger; and
creating a second block including the first fingerprint data and the second fingerprint data at every change in custody of the item on a networked distributed ledger.

9. The method as claimed in claim 8, comprising rejecting the change in custody of the item if the first fingerprint data is not identified on the networked distributed ledger.

10. The method as claimed in claim 8, comprising retrieving the primary data of the item from the memory and compare the primary data of the item with a pre-stored abnormalities parameter related to the item and generate a result, wherein the AI module authenticates the item based on the result.

11. The method as claimed in claim 8, comprising identifying the abnormalities in the item based on the generated result and sending an alert to the authorities, wherein the alert includes item information and information of last change of custody stored on the networked distributed ledger.

12. The method as claimed in claim 8, wherein if the first block is not identified on the networked distributed ledger, a genesis block is created and appending the second fingerprint data to the genesis block on the networked distributed ledger.

13. The method as claimed in claim 8, wherein the second fingerprint data is an encrypted data which includes a hash data.

14. A device for ensuring the credibility of an item among a plurality of change in custody of the said items in a supply chain management, the device comprising:
at least one computing device which includes at least one display unit having at least user interface, at least one input unit, one processor, a communication unit, at least one sensor and a memory unit stored executing instructions;
the one or more processor coupled to at least one display unit having at least user interface, at least one input unit, the communication unit, the at least one sensor and the memory, wherein responsive to executing the instructions, the processor performs operations comprising;
receiving an input on a computing device from a user, the input related to an action to be performed about the item;
capturing raw data related to the said item via a sensor at a vision module and storing the raw data in a memory;
identifying a primary data from the raw data based on at least one predefined parameter and store the primary data in the memory, the identification is done by an object recognition and character recognition (OCR) module, wherein the primary data is associated with the said item;
retrieving the raw data and primary data by an AI module to generate a second fingerprint data based on the primary data and the at least one predefined parameter;
identifying at least one first block having a first fingerprint data related to the item, wherein the first block is stored on a networked distributed ledger; and
creating a second block including the first fingerprint data and the second fingerprint data at every change in custody of the item on a networked distributed ledger.
